(19) United States
(12) Patent Application Publication
(10) Pub. No.: US 2026/0326325 A1
(43) Pub. Date: Oct. 22, 2026

(54) RAZOR HANDLE

(71) Applicant: DORCO CO., LTD., Seoul (KR)

(72) Inventor: Sang Hun PARK, Seoul (KR)

(21) Appl. No.: 19/641,204

(22) Filed: Apr. 7, 2026

(30) Foreign Application Priority Data
Apr. 17, 2025 (KR) 10-2025-0050441
Mar. 17, 2026 (KR) 10-2026-0048127

(51) Int. Cl. B26B 21/52; B26B 21/22

(52) U.S. Cl. CPC B26B 21/521; B26B 21/526; B26B 21/225

(57) ABSTRACT

A razor handle may be configured to be coupled with a razor cartridge including at least one blade. The razor handle may include a head portion to which the razor cartridge is coupled at a front side, a grip portion extending rearward from the head portion. The razor handle may also include a vibration source provided in at least one of the head portion and the grip portion to provide vibration. The vibration source may include an eccentric weight rotating about a rotational axis substantially parallel to a width direction of the grip portion.

### CROSS REFERENCE TO RELATED APPLICATION

This application claims priority to Korean patent application number 10-2025-0050441 filed on Apr. 17, 2025, and Korean patent application number 10-2026-0048127 filed on Mar. 17, 2026, the entire disclosure of each of which is incorporated by reference herein for all purposes.

### BACKGROUND

### Technical Field

The present disclosure relates to a razor handle, and more particularly, to a razor handle configured to be coupled with a razor cartridge.

### Description of Related Technology

In general, a razor is a device for shaving body hair such as facial hair or fine hair on the body, and includes a razor handle for gripping and a razor cartridge provided with blades that come into contact with the skin to perform shaving.

### SUMMARY

One aspect is a razor handle and a razor assembly including the same, which suppress vibrations that cause skin irritation and generate vibrations that improve shaving performance and shaving comfort.

The aspects of the present disclosure are not limited to those described herein, and other aspects not described herein will be clearly understood by those skilled in the art from the following description.

Another aspect is a razor handle configured to be coupled with a razor cartridge including at least one blade, the razor handle comprising: a head portion to which the razor cartridge is coupled at a front side; a grip portion extending rearward from the head portion; and a vibration source provided in at least one of the head portion and the grip portion to provide vibration, wherein the vibration source includes an eccentric weight rotating about a rotational axis substantially parallel to a width direction of the grip portion, such that a longitudinal vibration distance of the razor cartridge is smaller than each of a lateral vibration distance and a vertical vibration distance.

Another aspect is a razor handle configured to be coupled with a razor cartridge including at least one blade, the razor handle comprising: a head portion coupled with the razor cartridge; a grip portion extending from the head portion; and a vibration source provided in at least one of the head portion and the grip portion to provide vibration, wherein the vibration source provides vibration such that a longitudinal vibration distance of the razor cartridge is 10% or less of each of a lateral vibration distance and a vertical vibration distance.

Other specific features of the present disclosure are included in the detailed description and the drawings.

According to embodiments of the present disclosure, at least the following effects may be obtained.

Vibration components in a longitudinal direction that may cause skin irritation may be suppressed, and vibration components in a lateral direction and/or a vertical direction that contribute to shaving performance and shaving comfort may be dominantly provided.

The effects according to the present disclosure are not limited to those exemplified above, and more various effects are included in the present specification.

### BRIEF DESCRIPTION OF THE DRAWINGS

FIG. 1 is a perspective view of a razor assembly according to an embodiment of the present disclosure.

FIG. 2 is a perspective view of a razor assembly illustrating a state in which a razor handle and a razor cartridge are separated according to an embodiment of the present disclosure.

FIG. 3 is a plan view illustrating a top surface of a razor cartridge according to an embodiment of the present disclosure.

FIG. 4 is a perspective view illustrating a bottom surface of a razor cartridge according to an embodiment of the present disclosure.

FIG. 5 is an exploded perspective view of a head portion of a razor handle according to an embodiment of the present disclosure.

FIG. 6 is an exploded perspective view of a connecting portion of a razor handle according to an embodiment of the present disclosure.

FIG. 7 is a perspective view illustrating a release button of a razor handle according to an embodiment of the present disclosure.

FIG. 8 is an exploded perspective view of a damping portion of a razor handle according to an embodiment of the present disclosure.

FIG. 9 is a cross-sectional view schematically illustrating an internal configuration of a grip portion of a razor handle according to an embodiment of the present disclosure.

FIG. 10 is an exploded perspective view of a vibration source of a razor handle according to an embodiment of the present disclosure.

FIG. 11 is a view for explaining vibration characteristics of a razor cartridge according to an embodiment of the present disclosure.

FIGS. 12 and 13 are views for comparing vibration characteristics according to an arrangement of the vibration source.

### DETAILED DESCRIPTION

Some razors have employed technologies that generate vibration during shaving in order to improve shaving efficiency. However, when the direction or components of the vibration are not properly controlled, vibration components in the longitudinal direction of the razor cartridge (for example, in the extending direction of the blades) may occur, which may hinder precise shaving or cause skin cuts and/or skin irritation.

The advantages and features of the present disclosure, and methods for achieving the same, will become apparent with reference to the embodiments described below in detail in conjunction with the accompanying drawings. However, the present disclosure is not limited to the embodiments disclosed herein and may be implemented in various different forms. These embodiments are provided only to make the disclosure of the present disclosure complete and to fully convey the scope of the invention to those skilled in the art, and the present disclosure is defined only by the scope of the claims.

In addition, the embodiments described in the present specification will be explained with reference to idealized cross-sectional views and/or schematic diagrams. Accordingly, shapes illustrated in the drawings may be modified due to manufacturing techniques and/or tolerances. Further, in the drawings of the present disclosure, each component may be illustrated as being somewhat exaggerated or reduced in size for convenience of description. Throughout the specification, like reference numerals refer to like components.

Further, as used herein, the expressions “parallel,” “perpendicular,” “substantially parallel,” and “substantially perpendicular” include relationships that would be understood by those skilled in the art in consideration of manufacturing and assembly tolerances, deformation during use, measurement errors, and the like. For example, “substantially parallel” or “substantially perpendicular” includes not only cases of exact geometric correspondence but also cases deviating to some extent from such relationships.

Hereinafter, the present disclosure will be described with reference to drawings for explaining a razor assembly, a razor handle, and a razor cartridge according to an embodiment of the present disclosure.

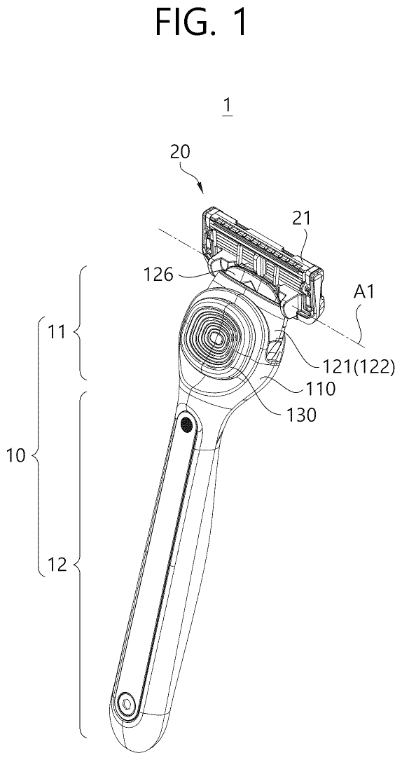

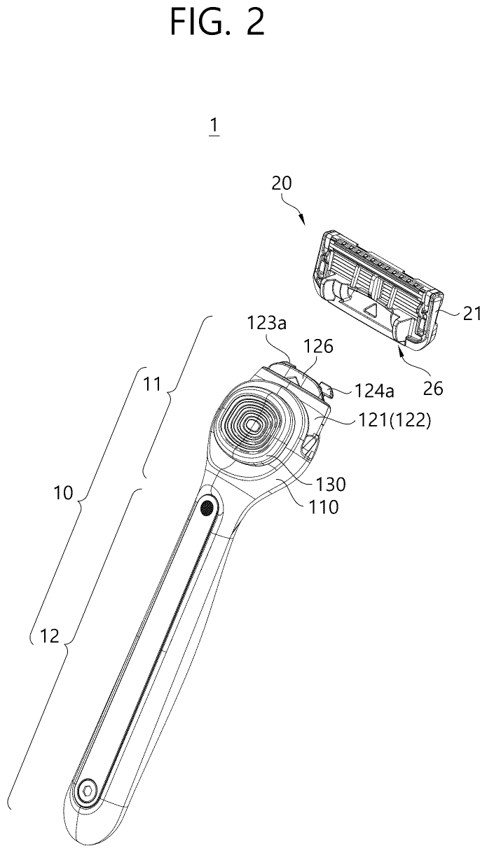

FIG. 1 is a perspective view of a razor assembly according to an embodiment of the present disclosure, and FIG. 2 is a perspective view of a razor assembly illustrating a state in which a razor handle and a razor cartridge are separated according to an embodiment of the present disclosure.

Referring to FIGS. 1 and 2, a razor assembly 1 according to an embodiment of the present disclosure includes a razor handle 10 and a razor cartridge 20.

The razor handle 10 may be detachably coupled with the razor cartridge 20. In addition, the razor cartridge 20 may be coupled to the razor handle 10 so as to be pivotable within a predetermined angular range about a first pivot axis A1. Detailed descriptions of a detachable coupling structure and a pivotable coupling structure between the razor handle 10 and the razor cartridge 20 will be provided below.

The razor handle 10 may be divided into a head portion 11 and a grip portion 12.

The head portion 11 is provided at a front end of the razor handle 10, is detachably coupled with the razor cartridge 20, and may support the coupled razor cartridge 20 so as to be pivotable.

The grip portion 12 extends rearward from the head portion 11 and is a portion grasped by a user. A boundary between the head portion 11 and the grip portion 12 may be a point at which a width rapidly increases toward the front. However, the present disclosure is not limited thereto, and the shape of the boundary between the head portion 11 and the grip portion 12 may vary depending on the design of the razor handle.

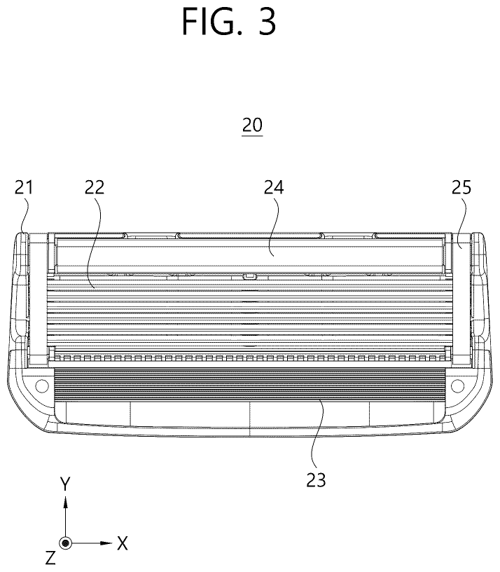

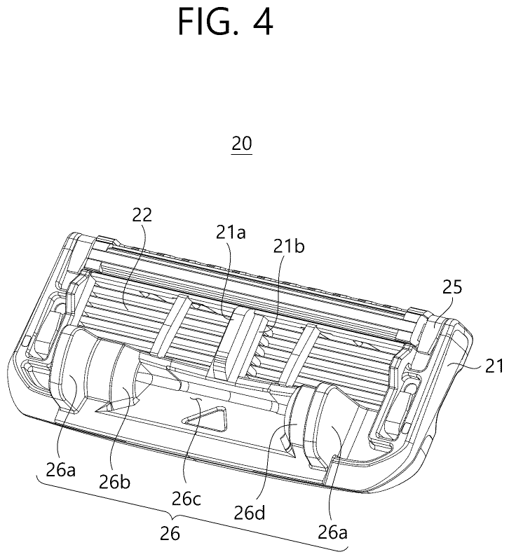

FIG. 3 is a plan view illustrating a top surface of a razor cartridge according to an embodiment of the present disclosure, and FIG. 4 is a perspective view illustrating a bottom surface of a razor cartridge according to an embodiment of the present disclosure.

In the following description of the razor cartridge 20 with reference to FIGS. 3 and 4, a longitudinal direction refers to a lengthwise direction of the razor cartridge 20. For example, the longitudinal direction may be substantially parallel to an X-axis in FIG. 3. A lateral direction refers to a width direction of the razor cartridge 20 perpendicular to the longitudinal direction. For example, the lateral direction may be substantially parallel to a Y-axis in FIG. 3. Along the lateral direction, a negative Y-axis direction may be a front direction, and a positive Y-axis direction may be a rear direction. A vertical direction refers to a height direction of the razor cartridge 20. For example, the vertical direction (or height direction) may be substantially parallel to a Z-axis in FIG. 3. Along the vertical direction, a positive Z-axis direction may be an upward direction, and a negative Z-axis direction may be a downward direction. The X-axis may be substantially parallel to the first pivot axis A1.

Referring to FIGS. 3 and 4, the razor cartridge 20 includes a blade housing 21 and at least one blade 22, and may further include at least one of a guard 23 and a lubricating band 24.

The blade housing 21 accommodates at least one blade 22 in the longitudinal direction, and a plurality of blades 22 may be arranged in a row in the lateral direction within the blade housing 21. Although FIG. 3 illustrates an example in which the razor cartridge 20 includes six blades 22, the number of blades 22 may vary depending on embodiments.

Referring to FIGS. 3 and 4, the razor cartridge 20 may further include a clip 25. The clip 25 is configured to prevent the blade 22 from being separated from the blade housing 21. The clip 25 may be bent into a substantially U-shape so as to surround both sides of the blade housing 21 in which the blade 22 is seated. However, the structure of the clip 25 may be variously modified to achieve the purpose of preventing separation of the blade 22, and in some embodiments, the clip 25 may be omitted when another configuration for preventing separation of the blade 22 is employed.

The top surface of the razor cartridge 20 illustrated in FIG. 3 is a surface that contacts or faces a user's skin during a shaving process. A cutting edge formed at an end of the blade 22 is exposed through the top surface of the blade housing 21, and may be inclined toward a shaving direction, which is a forward direction of the blade housing 21.

The guard 23 may be provided on a front upper surface of the blade housing 21.

The guard 23 positioned in front of the blade 22 comes into close contact with a user's skin during shaving to pull the skin, thereby improving the shaving effect of the blade 22. In order for the guard 23 to more effectively pull the user's skin, a pattern formed as a protrusion or recess may be provided on an upper surface of the guard 23, and the upper surface of the guard 23 may be formed of a material such as rubber or silicone. In some embodiments, the guard 23 may be provided as a separate component from the blade housing 21.

The lubricating band 24 may be provided on a rear upper surface of the blade housing 21.

The lubricating band 24 positioned behind the blade 22 includes a lubricating material, and allows the lubricating material to be applied to a skin surface over which the blade 22 has passed during shaving. The lubricating material may include components for protecting the skin after shaving.

Referring to FIG. 4, the blade housing 21 may include a cam 21a and a cam support portion 21b formed on a bottom surface thereof. The cam support portion 21b is provided at a central portion of the bottom surface of the blade housing 21 and may support lower portions of the plurality of blades 22. The cam 21a protrudes downward from the cam support portion 21b and may contact a plunger 126, which will be described later, to define a pivoting motion of the razor cartridge 20.

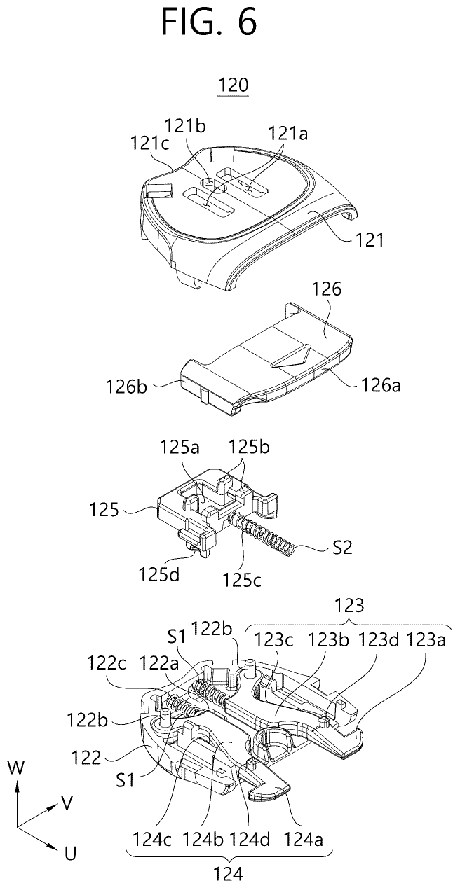

Referring to FIG. 4, the blade housing 21 may further include a connector coupling portion 26. The connector coupling portion 26 is configured to be detachably coupled with connecting arms 123 and 124 of the razor handle 10 (see FIG. 6). The connector coupling portion 26 may be provided on the bottom surface of the blade housing 21, and may be coupled to the blade housing 21 or integrally formed with the blade housing 21.

In order to allow shaving residues (for example, shaving cream and cut body hair) to be effectively discharged together with washing water through spaces between the plurality of blades 22, the connector coupling portion 26 may be formed at a position that does not overlap the blades 22 in a vertical direction. In this case, the connector coupling portion 26 may be positioned below the guard 23.

The connector coupling portion 26 may include a pair of guide posts 26a, a pair of guide surfaces 26b, and a receiving space 26c.

The pair of guide posts 26a may protrude from the blade housing 21 while being spaced apart from each other in the longitudinal direction with the receiving space 26c interposed therebetween. The receiving space 26c forms a space into which connecting arms 123 and 124, which will be described later, are inserted.

The pair of guide surfaces 26b extend from the pair of guide posts 26a toward a center of the blade housing 21. The pair of guide surfaces 26b may be formed to partially cover both sides of the receiving space 26c. That is, the receiving space 26c may extend up to an upper portion of the pair of guide surfaces 26b.

The pair of guide surfaces 26b guide effectors 123a and 124a of the pair of connecting arms 123 and 124, which will be described later, to move closer to each other when the connecting arms 123 and 124 enter the receiving space 26c. To this end, each of the guide surfaces 26b may include an inclined surface forming a downward slope toward the receiving space 26c.

After passing the pair of guide surfaces 26b, the effectors 123a and 124a of the pair of connecting arms 123 and 124 enter the receiving space 26c and move away from each other again, and each of the effectors 123a and 124a is prevented from being separated rearward by the pair of guide surfaces 26b.

The receiving space 26c accommodates the effectors 123a and 124a of the pair of connecting arms 123 and 124 to form the first pivot axis A1 of the razor cartridge 20 with respect to the razor handle 10.

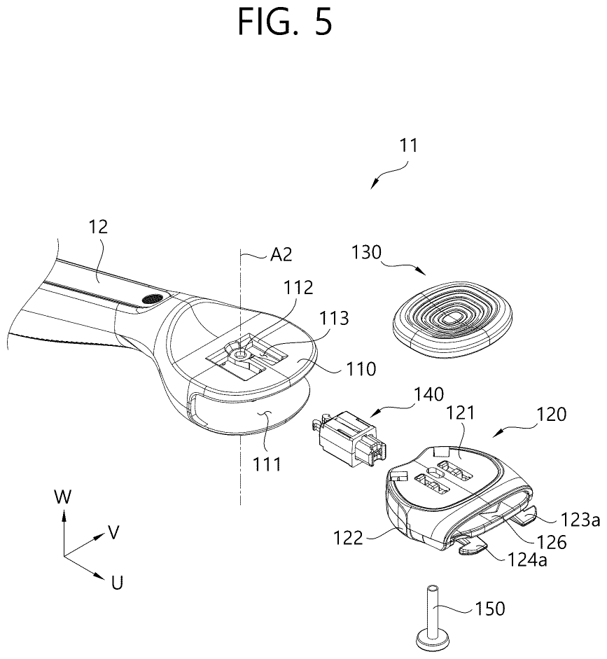

FIG. 5 is an exploded perspective view of a head portion of a razor handle according to an embodiment of the present disclosure.

In the following description of the razor handle 10, a direction in which the connecting portion 120 is located along a longitudinal direction of the razor handle 10 will be referred to as a front or a distal end side, and a direction in which a grip portion 12 is located will be referred to as a rear or a proximal end side. Further, referring to FIG. 5, the front may correspond to a positive U-axis direction, the rear may correspond to a negative U-axis direction, a width direction may correspond to a V-axis direction, an upward direction may correspond to a positive W-axis direction, and a downward direction may correspond to a negative W-axis direction. The width direction of the razor handle 10 may be substantially parallel to a longitudinal direction of the razor cartridge 20 in a neutral state. The neutral state of the razor cartridge 20 refers to a state in which no external force is applied while the razor cartridge 20 is coupled to the razor handle 10, and in the neutral state, a lateral central axis of the razor cartridge 20 may be positioned on a UW plane that bisects the razor handle 10 in the longitudinal direction.

Referring to FIG. 5, the razor handle 10 includes a head portion 11 and a grip portion 12.

The head portion 11 of the razor handle 10 may include a head housing 110, a connecting portion 120, a release button 130, a damping portion 140, and a coupling pin 150.

The head housing 110 defines an installation space 111 that accommodates the connecting portion 120 and the damping portion 140. The installation space 111 may be open toward the front. The damping portion 140 is positioned at a rear side of the installation space 111, and the connecting portion 120 may be positioned in front of the damping portion 140 within the installation space 111. The connecting portion 120 may be provided such that at least a portion of a plunger 126 and the connecting arms 123 and 124 is exposed through a front end of the head housing 110. The installation space 111 may be configured such that the connecting portion 120 is pivotable within a predetermined angular range about a second pivot axis A2. The second pivot axis A2 may be perpendicular to the first pivot axis A1. The second pivot axis A2 may be substantially parallel to the W-axis. In addition, the head housing 110 may be configured such that the connecting portion 120 is movable forward and rearward within a predetermined distance in the U-axis direction within the installation space 111.

An upper portion of the head housing 110 located above the installation space 111 may be formed with a first external pin hole 112 and a leg hole 113, each penetrating in a vertical direction. The first external pin hole 112 is configured to receive an upper end of the coupling pin 150. Although not illustrated, a second external pin hole corresponding to the first external pin hole 112 in the vertical direction may be formed in a lower portion of the head housing 110 located below the installation space 111. The coupling pin 150 may pass sequentially through the second external pin hole and the first external pin hole 112 and be fixed to the head housing 110.

The leg hole 113 is formed to allow legs 131 and 132 of the release button 130 to pass therethrough. The leg hole 113 may be formed longer in the front-rear direction than the legs 131 and 132 of the release button 130 so that the release button 130 can move a predetermined distance in the front-rear direction. Since the release button 130 according to this embodiment includes two legs 131 and 132 spaced apart in the width direction, two leg holes 113 spaced apart in the width direction may be formed in the head housing 110. The first external pin hole 112 may be positioned between the two leg holes 113. The leg holes 113 may be variously modified depending on the structure of the legs 131 and 132.

FIG. 6 is an exploded perspective view of a connecting portion of a razor handle according to an embodiment of the present disclosure.

Referring to FIG. 6, the connecting portion 120 may include connector housings 121 and 122, a pair of connecting arms 123 and 124, an ejector 125, and a plunger 126.

The connector housings 121 and 122 provide a space in which the pair of connecting arms 123 and 124, the ejector 125, and the plunger 126 are accommodated, and a structure in which they are installed. The connector housings 121 and 122 may be formed such that a front end thereof is open so that distal end portions of the pair of connecting arms 123 and 124 and the plunger 126 are exposed to the outside. The connector housings 121 and 122 may include an upper housing 121 and a lower housing 122.

An upper through slit 121a penetrating in a vertical direction may be formed in the upper housing 121. The upper through slit 121a is a space through which legs 131 and 132 of a release button 130, which will be described later, pass. In order to allow the release button 130 to move between a neutral position and an actuated position, the upper through slit 121a may be formed to extend in a front-rear direction. The upper through slit 121a may also accommodate at least a portion of a leg supporter 125b of the ejector 125. In this embodiment, since the release button 130 includes two legs 131 and 132, two upper through slits 121a are illustrated as being formed in the upper housing 121; however, the number and/or positions of the upper through slits 121a may be modified depending on embodiments.

The upper housing 121 may further include a first internal pin hole 121b penetrating in the vertical direction. The first internal pin hole 121b is a space through which the coupling pin 150 passes. In order to allow the connecting portion 120 to move within a predetermined distance in the front-rear direction relative to the head housing 110, the first internal pin hole 121b may be formed longer in the front-rear direction than a diameter of the coupling pin 150. The first internal pin hole 121b may be formed between the two upper through slits 121a.

A rear end 121c of the upper housing 121 may be formed such that a central portion thereof is recessed forward. This structure is for elastic support and rotational restoration of the connector housings 121 and 122 by a damping portion 140, which will be described later. More detailed descriptions thereof will be provided below.

The lower housing 122 may include a second internal pin hole 122a and a pair of arm rotation shafts 122b. The second internal pin hole 122a is a space through which the coupling pin 150 passes and may be formed to overlap the first internal pin hole 121b in the vertical direction. In order to allow the connecting portion 120 to move within a predetermined distance in the front-rear direction relative to the head housing 110, the second internal pin hole 122a may also be formed longer in the front-rear direction than the diameter of the coupling pin 150.

In addition, the lower housing 122 may include first elastic member mounting protrusions 122c that respectively protrude toward the first connecting arm 123 and the second connecting arm 124. A first elastic member S1 that elastically supports between the first connecting arm 123 and the second connecting arm 124 and the lower housing 122 may be mounted on the first elastic member mounting protrusions 122c.

A rear end of the lower housing 122 may also be formed such that a central portion thereof is recessed forward corresponding to the rear end 121c of the upper housing 121.

The pair of connecting arms 123 and 124 may include a first connecting arm 123 and a second connecting arm 124.

The first connecting arm 123 and the second connecting arm 124 rotate about the pair of arm rotation shafts 122b by operation of the release button 130. The first connecting arm 123 and the second connecting arm 124 rotate about the arm rotation shafts 122b to be coupled to or separated from the connector coupling portion 26 of the razor cartridge 20.

The first connecting arm 123 may include a first effector 123a, a first driving arm 123b, and a first driving surface 123c. The second connecting arm 124 may include a second driving arm 124b, a second driving surface 124c, and a second effector 124a. The first connecting arm 123 and the second connecting arm 124 may be formed symmetrically with respect to each other.

A rear end of the first driving arm 123b is rotatably mounted to the arm rotation shaft 122b and extends toward the open front end of the connector housings 121 and 122.

The first driving surface 123c may form at least a portion of an outer surface of the first driving arm 123b. The first driving surface 123c may be formed to have an inclination toward a distal end. This is to allow the first driving surface 123c to interfere with a leg 125d of the ejector 125 as the ejector 125 moves toward the distal end, thereby rotating the first connecting arm 123 in a clockwise direction. However, the present disclosure is not limited thereto, and various structures may be applied in which rotational movement of the first connecting arm 123 is achieved by movement of the ejector 125. The first elastic member S1 elastically supports the first driving arm 123b to provide a restoring force that rotates the first connecting arm 123 in a counterclockwise direction.

The first effector 123a may be provided at a distal end of the first driving arm 123b. The first effector 123a is detachably coupled with the connector coupling portion 26. In this embodiment, a hook shape is illustrated as an example of the shape of the first effector 123a; however, the shape of the first effector 123a may be modified as long as it can be detachably coupled with the connector coupling portion 26.

A first interference protrusion 123d may be formed on an upper surface of the first driving arm 123b. The first interference protrusion 123d may interfere with a structure formed on a lower surface of the plunger 126 to limit a rotation range of the first connecting arm 123.

The second connecting arm 124 may include a second effector 124a, a second driving arm 124b, a second driving surface 124c, and a second interference protrusion 124d. The first connecting arm 123 and the second connecting arm 124 may be formed symmetrically with respect to each other, and the second effector 124a, the second driving arm 124b, the second driving surface 124c, and the second interference protrusion 124d perform functions similar to those of the first effector 123a, the first driving arm 123b, the first driving surface 123c, and the first interference protrusion 123d described above, and thus detailed descriptions thereof will be omitted.

The ejector 125 is positioned above the pair of connecting arms 123 and 124.

The ejector 125 is configured to rotate the pair of connecting arms 123 and 124 about the arm rotation shafts 122b in conjunction with the release button 130. Accordingly, the pair of connecting arms 123 and 124 installed within the connector housings 121 and 122 may be rotated by operation of the release button 130 exposed to an outside of the razor handle 10.

The ejector 125 may include leg receiving holes 125a in which the legs 131 and 132 of the release button 130 are received. The legs 131 and 132 of the release button 130 may pass through the leg receiving holes 125a and be hook-coupled with the ejector 125. However, depending on embodiments, a coupling manner between the legs 131 and 132 of the release button 130 and the ejector 125 may vary.

Leg supporters 125b supporting the legs 131 and 132 may be provided at edges of the leg receiving holes 125a. The leg supporters 125b may be configured to support both sides of the legs 131 and 132 along a movement direction of the release button 130. Accordingly, even when the release button 130 is operated, a firm coupling state between the legs 131 and 132 and the ejector 125 may be maintained, and play between the legs 131 and 132 and the ejector 125 may be prevented.

The ejector 125 may include a second elastic member mounting protrusion 125c that protrudes toward the plunger 126. A second elastic member S2 provided between the ejector 125 and the plunger 126 may be mounted on the second elastic member mounting protrusion 125c. The second elastic member S2 provides an elastic restoring force that pushes the plunger 126 toward the distal end, thereby enabling restoration of pivoting of the razor cartridge 20 about the first pivot axis A1.

The ejector 125 may include a plurality of legs 125d extending downward.

At least some of the plurality of legs 125d are positioned to contact the first driving surface 123c and the second driving surface 124c, respectively, and as the ejector 125 moves forward and backward, the first connecting arm 123 and the second connecting arm 124 rotate about the arm rotation shafts 122b, respectively, by interaction between the legs 125d and the first driving surface 123c and the second driving surface 124c.

The plunger 126 may be provided within the connector housings 121 and 122 so as to be movable forward and backward toward the distal end. Referring to FIGS. 2 and 5, a distal end of the plunger 126 is exposed to the outside through a distal end of the razor handle 10 and may be positioned to cover upper portions of the pair of connecting arms 123 and 124.

A distal end 126a of the plunger 126 contacts the cam 21a of the razor cartridge 20 and provides a restoring force for pivoting of the razor cartridge 20 about the first pivot axis A1.

Side walls 126b extending downward may be provided on both sides of the plunger 126. The side walls 126b may be positioned between each of the connecting arms 123 and 124 and side walls of the lower housing 122, and may guide a forward and backward movement direction of the plunger 126 while being in contact with the side walls of the lower housing 122.

Although not illustrated, a protrusion receiving groove that accommodates at least a portion of the second elastic member mounting protrusion 125c and the second elastic member S2 may be formed at a rear end of the plunger 126. The protrusion receiving groove may accommodate a portion of the second elastic member mounting protrusion 125c when a distance between the plunger 126 and the ejector 125 is reduced.

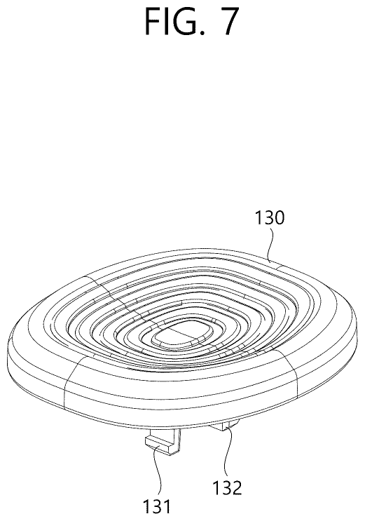

FIG. 7 is a perspective view illustrating a release button of a razor handle according to an embodiment of the present disclosure.

An upper surface of the release button 130 is a portion that directly contacts a user's finger and may have an overall curved shape. In this embodiment, an example is illustrated in which the upper surface of the release button 130 is generally concave downward; however, depending on embodiments, at least a portion of the upper surface may be formed as a convex curved surface.

The upper surface of the release button 130 is preferably formed to have a color different from that of the head housing 110, which will be described later, so that a user can easily visually recognize the release button 130.

As described above, the legs 131 and 132 of the release button 130 pass through the upper through slits 121a and are coupled with the ejector 125. In this embodiment, a hook shape is illustrated as a structure of a leg 132b for coupling with the ejector 125; however, depending on embodiments, the leg 132b may be modified to another structure capable of being coupled with the ejector 125.

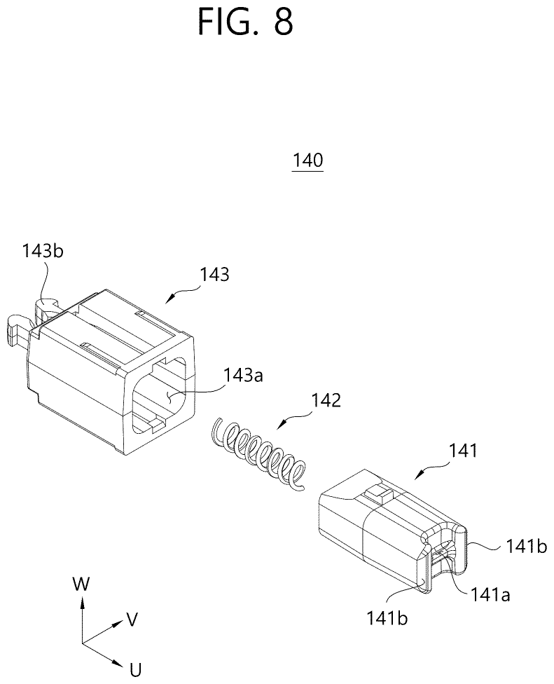

FIG. 8 is an exploded perspective view of a damping portion of a razor handle according to an embodiment of the present disclosure.

Referring to FIG. 8, the damping portion 140 may include a pressing portion 141, an elastic portion 142, and a fixing portion 143.

The pressing portion 141 elastically supports a rear surface of the connector housings 121 and 122.

A distal end of the pressing portion 141 may include a central portion 141a that is concave rearward and contact portions 141b extending forward from both sides of the central portion 141a in a width direction. The rear surface of the connector housings 121 and 122 may contact the contact portions 141b and may not contact the central portion 141a. Accordingly, a contact area between the connector housings 121 and 122 and the pressing portion 141 may be reduced, so that the connecting portion 120 can smoothly pivot about the second pivot axis A2. In addition, even when the connecting portion 120 pivots clockwise or counterclockwise about the second pivot axis A2, at least one of the pair of contact portions 141b of the pressing portion 141 maintains contact with the connector housings 121 and 122 and may provide a restoring force in a pivoting direction to the connector housings 121 and 122.

The fixing portion 143 defines a receiving groove 143a that is open forward. The pressing portion 141 is installed within the receiving groove 143a such that the contact portions 141b are exposed forward of the fixing portion 143. The fixing portion 143 may include a structure for preventing forward separation of the pressing portion 141. A mounting member 143b may be provided at a rear end of the fixing portion 143. The mounting member 143b may be formed in a structure fixed within the head housing 110. Although FIG. 8 illustrates an example in which the mounting member 143b has a hook structure, the present disclosure is not limited thereto, and various coupling structures may be applied.

The elastic portion 142 provides an elastic force that pushes the pressing portion 141 forward within the receiving groove 143a. The elastic force of the elastic portion 142 may act as a restoring force provided by the pressing portion 141 to the connecting portion 120.

For example, when the razor cartridge 20 and the connecting portion 120 pivot about the second pivot axis A2 due to a force applied during shaving, the pressing portion 141 elastically supported by the elastic portion 142 provides a restoring force to the connecting portion 120 so that the connecting portion 120 and the razor cartridge 20 are aligned to an original position.

In addition, even when the connecting portion 120 retreats relative to the head housing 110 due to an impact or a force applied during shaving, the pressing portion 141 elastically supported by the elastic portion 142 absorbs the impact and provides a restoring force that allows the connecting portion 120 to advance back to its original position.

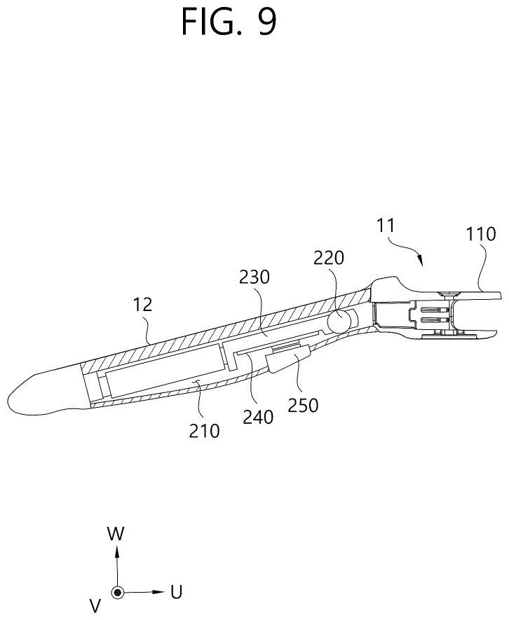

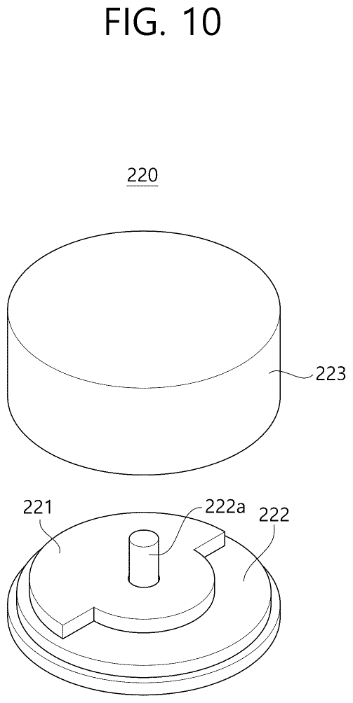

FIG. 9 is a cross-sectional view schematically illustrating an internal configuration of a grip portion of a razor handle according to an embodiment of the present disclosure, and FIG. 10 is an exploded perspective view of a vibration source of a razor handle according to an embodiment of the present disclosure.

Referring to FIGS. 9 and 10, the razor handle 10 may further include a vibration source 220. The vibration source 220 may provide vibration to the razor cartridge 20 coupled to the razor handle 10.

Referring to FIG. 10, the vibration source 220 may include an eccentric weight 221 that rotates about a rotational axis 222a. The vibration source 220 may include a lower housing 222 and an upper housing 223 that accommodate the eccentric weight 221, and the eccentric weight 221 may rotate within the lower housing 222 and the upper housing 223 to generate vibration. The vibration source 220 may be a coin motor that receives power to rotate the eccentric weight 221.

In order for vibration to be effectively transmitted to the razor cartridge 20, the vibration source 220 may be provided as close as possible to the razor cartridge 20. However, since the razor handle 10 detachably coupled with the razor cartridge 20 includes the connecting portion 120 in the head portion 11, it is difficult to install the vibration source 220 in the head portion 11. Accordingly, the vibration source 220 may be provided in the grip portion 12 and may be disposed at a front end side of the grip portion 12 adjacent to the head portion 11. In addition, the vibration source 220 may be positioned rearward of the first pivot axis A1 and the second pivot axis A2. By disposing the vibration source 220 in a region adjacent to the head portion 11 and on a rear side of the first pivot axis A1 and the second pivot axis A2, a vibration transmission path to the head portion 11 is shortened, structural damping is minimized, and effective vibration components may be stably and efficiently transmitted to the razor cartridge 20 without interference with pivoting motions about the first pivot axis A1 and/or the second pivot axis A2. As a result, shaving efficiency is improved and skin irritation is reduced. In addition, since a wiring path to a battery 210 and a circuit board 240 is shortened, a circuit configuration may be simplified. However, depending on embodiments, the vibration source 220 may be provided in the head portion 11.

Appropriate vibration provided to the razor cartridge 20 may contribute to improving a skin massage function and a function of aligning body hair. However, excessive vibration may hinder precise shaving and cause skin cuts.

In order to provide vibration that improves shaving performance, a mass of the eccentric weight 221 may be 0.1 g to 0.5 g (for example, 0.2 g), a rotation radius of the eccentric weight 221 may be 1.5 mm to 2.5 mm (for example, 1.9 mm), and a rotation speed of the eccentric weight 221 may be 10,000 rpm ±10% or 9,000 rpm to 11,000 rpm.

Referring to FIG. 10, the razor handle 10 may further include a battery 210, a support portion 230, a circuit board 240, and a switch 250 in order to operate the vibration source 220.

The battery 210 may be an AA battery or an AAA battery; however, in some embodiments, a rechargeable battery may be used. The battery 210 may be replaceably installed inside the grip portion 12.

The support portion 230 may be provided inside the grip portion 12 to fix the battery 210 and the vibration source 220 within the razor handle 10. The support portion 230 may include a part of a circuit that electrically connects the battery 210 and the vibration source 220.

The circuit board 240 may also be provided inside the grip portion 12 and may be supported by the support portion 230.

The switch 250 may be partially connected to the circuit board 240 and partially exposed to the outside of the razor handle 10, such that the circuit board 240 is configured to turn the vibration source 220 ON or OFF by operation of a user. As the switch 250, a mechanical switch that toggles between ON and OFF states, a capacitive touch switch that is activated by a user's finger, an optical switch, or the like may be used.

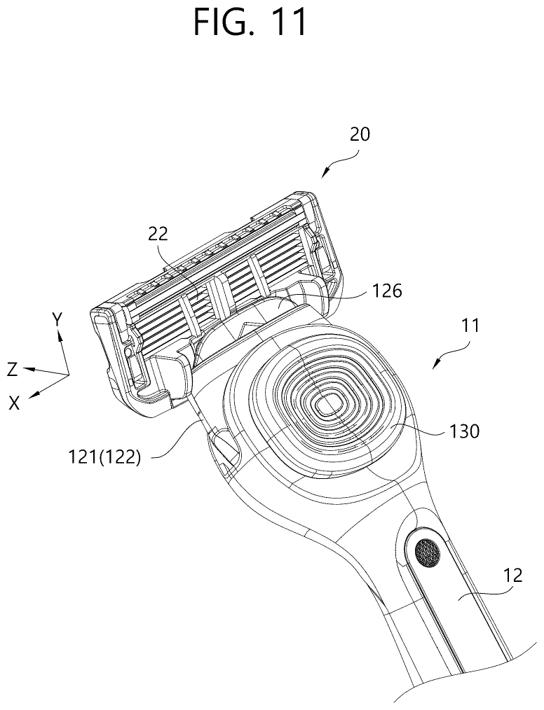

FIG. 11 is a view for explaining vibration characteristics of a razor cartridge according to an embodiment of the present disclosure.

Referring to FIG. 11, vibration generated by the vibration source 220 may be divided into vibrations acting in X-, Y-, and Z-axis directions on an upper surface of the razor cartridge 20 that contacts the skin. When vibration of the razor cartridge 20 is controlled based on coordinate axes X, Y, and Z, prevention of cuts or nicks, skin massage, and body hair alignment functions may be improved.

Vibration acting in the X-axis direction, that is, vibration acting in a longitudinal direction of the razor cartridge 20 and in an extending direction of the blade 22, may hinder precise shaving and may cause skin cuts and/or skin irritation.

Vibration acting in the Y-axis direction, that is, vibration acting in a lateral direction of the razor cartridge 20 and in a shaving direction, improves shaving performance. In particular, vibration acting in the Y-axis direction improves a cutting capability of body hair and may suppress a phenomenon in which the blade 22 fails to fully cut the body hair and instead catches on the body hair or cuts only a portion thereof, thereby pulling the body hair. In addition, vibration acting in the Y-axis direction during cleaning of the razor cartridge 20 may assist in discharging residues remaining in the razor cartridge 20.

Vibration acting in the Z-axis direction, that is, vibration acting in a height direction of the razor cartridge 20, stimulates the skin surface in an up-and-down direction to provide a skin massage effect, thereby reducing a sensation of irritation caused by the blade 22. In addition, vibration acting in the Z-axis direction improves contact between the blade 22 and the skin, thereby enabling deeper cutting of body hair. Further, vibration acting in the Z-axis direction during cleaning of the razor cartridge 20 may assist in discharging residues remaining in the razor cartridge 20.

Accordingly, vibration acting in the Y-axis direction and/or the Z-axis direction is advantageous for shaving, whereas vibration acting in the X-axis direction causes skin irritation and is therefore preferably suppressed as much as possible.

The vibration source 220 according to this embodiment provides vibration in which a longitudinal (X-axis direction) vibration distance of the razor cartridge 20 is smaller than each of a lateral (Y-axis direction) vibration distance and a vertical (Z-axis direction) vibration distance. For example, the vibration source 220 preferably provides vibration such that the longitudinal (X-axis) vibration distance of the razor cartridge 20 is 10% or less of each of the lateral (Y-axis) vibration distance and the vertical (Z-axis) vibration distance. As used herein, ‘vibration distance’ refers to a displacement amplitude measured along each axis. In addition, the vibration source 220 according to this embodiment may provide vibration such that the vertical vibration distance of the razor cartridge 20 is greater than the lateral vibration distance. For example, the lateral (Y-axis) vibration distance of the razor cartridge 20 may be 25 μm or more, and the vertical (Z-axis) vibration distance may be 50 μm or more.

The vibration source 220 according to this embodiment may be installed such that the rotational axis 222a is substantially parallel to a width direction of the grip portion 12. Alternatively, the vibration source 220 may be installed to be substantially parallel to the first pivot axis A1 of the razor cartridge 20 in a neutral state. Alternatively, the vibration source 220 may be installed to be substantially parallel to a longitudinal direction (i.e., an extending direction of the blade 22) of the razor cartridge 20 in a neutral state. The width direction of the grip portion 12 and the first pivot axis A1 of the razor cartridge 20 in the neutral state may be substantially parallel, and the first pivot axis A1 of the razor cartridge 20 may be substantially parallel to the longitudinal direction of the razor cartridge 20. In this case, the vibration source 220 predominantly generates vibration in a plane perpendicular to the rotational axis 222a (i.e., a UW plane and/or a YZ plane), thereby suppressing vibration components in the X-axis direction and predominantly generating vibration components in the Y-axis and Z-axis directions. Through this arrangement, excessive oscillation in the X-axis direction may be minimized, while Y-axis and Z-axis components contributing to shaving performance may be effectively secured.

Under the above-described arrangement of the vibration source 220, it is preferable to control an amplitude in the X-axis direction of the razor cartridge 20 to be 10% or less of amplitudes in the Y-axis and Z-axis directions. For example, the amplitude in the Y-axis direction may be 25 μm or more, and the amplitude in the Z-axis direction may be 50 μm or more. Such axis-specific amplitude control minimizes interference with pivoting about the first pivot axis A1 and the second pivot axis A2 of the head, thereby stabilizing effective vibration transmission to a vicinity of the blade 22.

As a result, by suppressing the X-axis component, skin cuts and irritation may be reduced, while strengthening the Y-axis and Z-axis components improves cutting efficiency, contact between the blade 22 and the skin, and discharge of residues during cleaning.

In an experimental result in which an eccentric weight 221 having a mass of 0.2 g was rotated at a rotation radius of 1.9 mm and a rotation speed of 10,000 rpm ±10%, a longitudinal vibration distance of the razor cartridge 20 was measured as 0 μm, a lateral vibration distance was 32 μm, a vertical vibration distance was 60 μm, and a vibration frequency was 170 Hz.

Meanwhile, since vibration generated by the vibration source 220 acts in a direction substantially parallel to the UW plane and/or the YZ plane, vibration in the X-axis direction is suppressed regardless of a rotation angle of the razor cartridge 20 about the first pivot axis A1, and vibration characteristics in the Y-axis and Z-axis directions do not significantly change. This means that even when the razor cartridge 20 rotates about the first pivot axis A1 during shaving, vibration characteristics perceived by a user do not significantly change, and shaving characteristics harmful to shaving do not occur.

Meanwhile, the vibration source 220 may be positioned rearward of the second pivot axis A2. More preferably, the vibration source 220 may be positioned rearward of the damping portion 140. This prevents interference between a structure that allows the connecting portion 120 to pivot about the second pivot axis A2 and the vibration source 220. In addition, this simplifies a circuit configuration connected to the vibration source 220. Further, this allows a portion of vibration generated by the vibration source 220 to be absorbed by the damping portion 140.

In particular, when the razor cartridge 20 pivots about the second pivot axis A2, even if vibration generated by the vibration source 220 acts in a direction substantially parallel to the UW plane, vibration in the X-axis direction may be induced depending on a pivot angle of the razor cartridge 20 about the second pivot axis A2. The damping portion 140 absorbs a portion of the vibration generated by the vibration source 220, thereby minimizing vibration in the X-axis direction occurring at the razor cartridge 20.

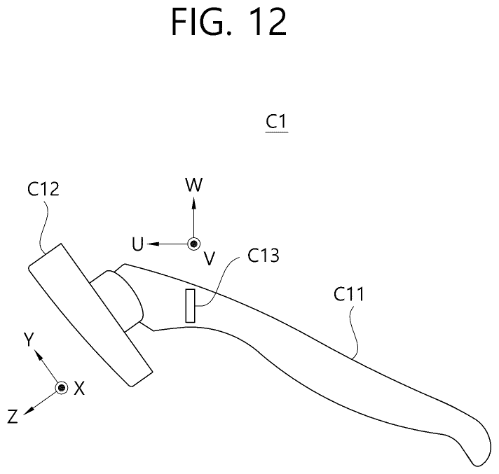

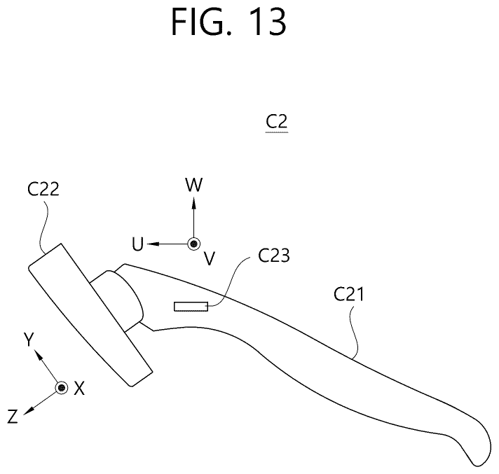

FIGS. 12 and 13 are views for comparing vibration characteristics according to an arrangement of a vibration source.

Referring to FIG. 12, a razor C1 according to a first comparative example includes a razor handle C11 and a razor cartridge C12, and the razor cartridge C12 is pivotably connected to the razor handle C11 about an axis substantially parallel to an X-axis direction and a V-axis direction.

A vibration source C13 may be configured such that an eccentric weight rotates about a rotational axis substantially parallel to a U-axis direction. In this case, vibration generated by the vibration source C13 predominantly appears within a plane perpendicular to the rotational axis and, for example, may generate primary vibration in a direction substantially parallel to a VW plane in FIG. 12.

In this case, due to changes in a pivot angle of the razor cartridge C12 and structural asymmetric transformation, vibration in the X-axis direction is generated at all pivot angles, thereby causing skin irritation. In addition, vibration in the Y-axis direction varies depending on the pivot angle but is generally weak. Further, vibration in the Z-axis direction also varies depending on the pivot angle, but tends to be large at angles where the razor cartridge C12 is not in close contact with the skin and weak at angles where the razor cartridge C12 is in close contact with the skin.

That is, in the razor C1 according to the first comparative example, vibrations (Y-axis and Z-axis vibrations) that improve shaving performance are weak, while vibration (X-axis vibration) that causes skin irritation is relatively large.

Referring to FIG. 13, a razor C2 according to a second comparative example includes a razor handle C21 and a razor cartridge C22, and the razor cartridge C22 is pivotably connected to the razor handle C21 about an axis substantially parallel to an X-axis direction and a V-axis direction.

A vibration source C23 may be configured such that an eccentric weight rotates about a rotational axis substantially parallel to a W-axis direction. In this case, vibration generated by the vibration source C23 predominantly appears within a plane perpendicular to the rotational axis and, for example, may generate primary vibration in a direction substantially parallel to a UV plane in FIG. 13.

In this case, as a pivot angle of the razor cartridge C22 changes, distributions of X-axis, Y-axis, and Z-axis components significantly vary, thereby making a shaving feel unstable, and vibration in the X-axis direction is generated at all pivot angles, causing skin irritation. In addition, vibration in the Y-axis direction and the Z-axis direction varies depending on the pivot angle, which may degrade shaving performance and shaving comfort.

That is, in the razor C2 according to the second comparative example, vibration characteristics vary depending on the pivot angle of the razor cartridge C22, thereby degrading shaving comfort and generating vibration that causes skin irritation.

As described with reference to the razors C1 and C2 according to the comparative examples, shaving performance and shaving comfort achieved vary significantly depending on an arrangement of the vibration source. In consideration thereof, in the razor assembly 1 according to an embodiment of the present disclosure, the vibration source 220 is arranged such that the rotational axis 222a of the eccentric weight 221 is substantially parallel to a width direction of the grip portion 12 (or to the first pivot axis A1 of the razor cartridge 20 in a neutral state, or to a longitudinal direction of the razor cartridge 20 in a neutral state), thereby stably securing effective vibration components (Y-axis and Z-axis) within a YZ plane perpendicular to the rotational axis 222a, regardless of pivoting of the razor cartridge 20 about the first pivot axis A1, and suppressing an X-axis component.

Those skilled in the art will appreciate that the present disclosure may be embodied in other specific forms without departing from the technical spirit or essential characteristics thereof. Therefore, the embodiments described above are to be understood in all respects as illustrative and not restrictive. The scope of the present disclosure is defined by the appended claims rather than the foregoing detailed description, and all changes or modifications derived from the meaning and scope of the claims and equivalents thereof should be construed as being included within the scope of the present disclosure.

What is claimed is:

1. A razor handle configured to be coupled with a razor cartridge including at least one blade, the razor handle comprising:
a head portion to which the razor cartridge is coupled at a front side;
a grip portion extending rearward from the head portion; and
a vibration source provided in at least one of the head portion or the grip portion to provide vibration,
wherein the vibration source includes an eccentric weight configured to rotate about a rotational axis parallel to a width direction of the grip portion, such that a longitudinal vibration distance of the razor cartridge is smaller than each of a lateral vibration distance and a vertical vibration distance.

2. The razor handle of claim 1, wherein the vibration source is provided at one side of the grip portion adjacent to the head portion.

3. The razor handle of claim 1, wherein the head portion is configured to support the razor cartridge so as to be pivotable within a predetermined angular range about a first pivot axis parallel to a longitudinal direction of the razor cartridge.

4. The razor handle of claim 3, wherein the head portion comprises:
a connecting portion configured to support the razor cartridge so as to be pivotable about the first pivot axis; and
a head housing configured to support the connecting portion so as to be pivotable about a second pivot axis perpendicular to the first pivot axis,
such that the razor cartridge is pivotable about the first pivot axis and the second pivot axis.

5. The razor handle of claim 4, wherein the vibration source is positioned rearward of the second pivot axis.

6. The razor handle of claim 1, further comprising:
a damping portion disposed between the vibration source and the razor cartridge and configured to absorb at least a portion of vibration generated from the vibration source.

7. The razor handle of claim 6, wherein the head portion comprises:
a connecting portion detachably coupled with the razor cartridge; and
a head housing configured to accommodate the connecting portion so as to be movable forward and backward within a predetermined distance,
wherein the damping portion is provided between the head housing and the connecting portion to elastically support the connecting portion relative to the head housing.

8. The razor handle of claim 1, wherein a mass of the eccentric weight is 0.1 g to 0.5 g.

9. The razor handle of claim 1, wherein a rotation radius of the eccentric weight is 1.5 mm to 2.5 mm.

10. The razor handle of claim 1, wherein a rotation speed of the eccentric weight is 10,000 rpm or more.

11. The razor handle of claim 1, wherein the vibration source is configured to vibrate at a frequency of 170 Hz or more.

12. The razor handle of claim 1, wherein the vibration source is configured to provide vibration such that a lateral vibration distance of the razor cartridge is 25 μm or more.

13. The razor handle of claim 1, wherein the vibration source is configured to provide vibration such that a vertical vibration distance of the razor cartridge is 50 μm or more.

14. The razor handle of claim 1, wherein the vibration source is configured to provide vibration such that a vertical vibration distance of the razor cartridge is greater than a lateral vibration distance of the razor cartridge.

15. The razor handle of claim 1, wherein the vibration source is configured to provide vibration such that a longitudinal vibration distance of the razor cartridge is 10% or less of each of a lateral vibration distance and a vertical vibration distance.

16. A razor handle configured to be coupled with a razor cartridge including at least one blade, the razor handle comprising:
a head portion coupled with the razor cartridge;
a grip portion extending from the head portion; and
a vibration source provided in at least one of the head portion or the grip portion to provide vibration,
wherein the vibration source is configured to provide vibration such that a longitudinal vibration distance of the razor cartridge is 10% or less of each of a lateral vibration distance and a vertical vibration distance.

17. The razor handle of claim 16, wherein the vibration source is configured to provide vibration such that a lateral vibration distance of the razor cartridge is 25 μm or more and a vertical vibration distance of the razor cartridge is 50 μm or more.
